(19) United States
(12) Patent Application Publication
(10) Pub. No.: US 2024/0329613 A1
(43) Pub. Date: Oct. 3, 2024

(54) Wireless Control System for a Household Appliance

(71) Applicant: Richard D Townsend, JR., Plano, TX (US)

(72) Inventor: Richard D Townsend, JR., Plano, TX (US)

(21) Appl. No.: 18/743,435

(22) Filed: Jun. 14, 2024

Related U.S. Application Data
(63) Continuation of application No. 17/517,214, filed on Nov. 2, 2021.
(60) Provisional application No. 63/108,603, filed on Nov. 2, 2020.

(51) Int. Cl. G05B 15/02; G08C 17/02; H02J 13/00; H04W 4/80

(52) U.S. Cl. CPC G05B 15/02; G08C 17/02; H02J 13/00022; H02J 13/00036; H04W 4/80

(57) ABSTRACT

A wireless control system for a household appliance is provided. The wireless control system for a household appliance includes an electronic housing. The electronic housing is dimensioned to and designed to be secured within a household appliance. The electronic housing includes a power kill switch. The power kill switch is connected to a power supply of the household appliance in a manner that enables the power supply of the household appliance to be enabled and disabled. The power kill switch is also connected to a wireless signal transceiver. The wireless signal transceiver is designed to receive activation and deactivation signals.

### CROSS REFERENCE TO RELATED APPLICATIONS

This application claims the benefit of U.S. Non-Provisional application Ser. No. 17/517,214 filed on Nov. 2, 2021 as a continuation, which claims benefit to U.S. Provisional Application No. 63/108,603 filed on Nov. 2, 2020. The above identified patent applications are herein incorporated by reference in their entirety to provide continuity of disclosure.

### BACKGROUND OF THE INVENTION

The present invention relates to a wireless control system for a household appliance. More specifically, the present system provides a mechanism through which a household appliance may be remotely enabled and disabled.

Electronic appliances are an essential part of life for most people. These appliances can include ovens, stoves, dishwashers, washers, dryers, televisions or any other device to assist users with tasks or to provide them with entertainment. As these devices continue to develop and to become more complex, their high costs have remained consistent. This has led to the formation of companies that offer rent-to-own deals on appliances. A risk associated with operating a rent-to-own company is that customers may fail to make a monthly payment or may outright attempt to steal an appliance. This may require the rent-to-own company to engage in a repossession of the product or to contact law enforcement officials to recover the product.

Conducting a repossession of the product may be expensive, and in some cases repossessions may be dangerous. Individuals, who are subjected to repossessions of important devices may try to prevent or resist the repossession. Furthermore, repossessions of large or heavy objects may require the use of specialized equipment, such as dollies, forklifts or other types of machinery. Since missed payments may be easily corrected by the renters, it is inconvenient and often unnecessary to conduct such a repossession. Therefore, there is a defined need amongst the known prior art references for a device that allows for remote deactivation of leased or rented home appliances.

### SUMMARY OF THE INVENTION

In view of the foregoing disadvantages inherent in the known types of household appliance power management systems now present in the prior art, the present invention provides a wireless control system for a household appliance wherein the same can be utilized for providing convenience for the user when remotely deactivating a household appliance.

The present system comprises an electronic housing. The electronic housing is configured to be secured within a household appliance. The electronic housing comprises a power kill switch. The power kill switch is in operable connection with a power supply of the household appliance. As such, the power supply of the household appliance may be enabled and disabled via the power kill switch. The power switch is in operable connection with a wireless signal receiver. The wireless signal transceiver is designed to receive activation and deactivation signals.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a first block diagram of an embodiment of the wireless control system for a household appliance.

FIG. 2 shows a second block diagram of an embodiment of the wireless control system for a household appliance.

FIG. 3 shows a demonstrative view of an embodiment of the wireless control system for a household appliance.

### DETAILED DESCRIPTION OF THE INVENTION

Reference is made herein to the attached drawings. Like reference numerals are used throughout the drawings to depict like or similar elements of the wireless control system for a household appliance. The figures are intended for representative purposes only and should not be considered to be limiting in any respect.

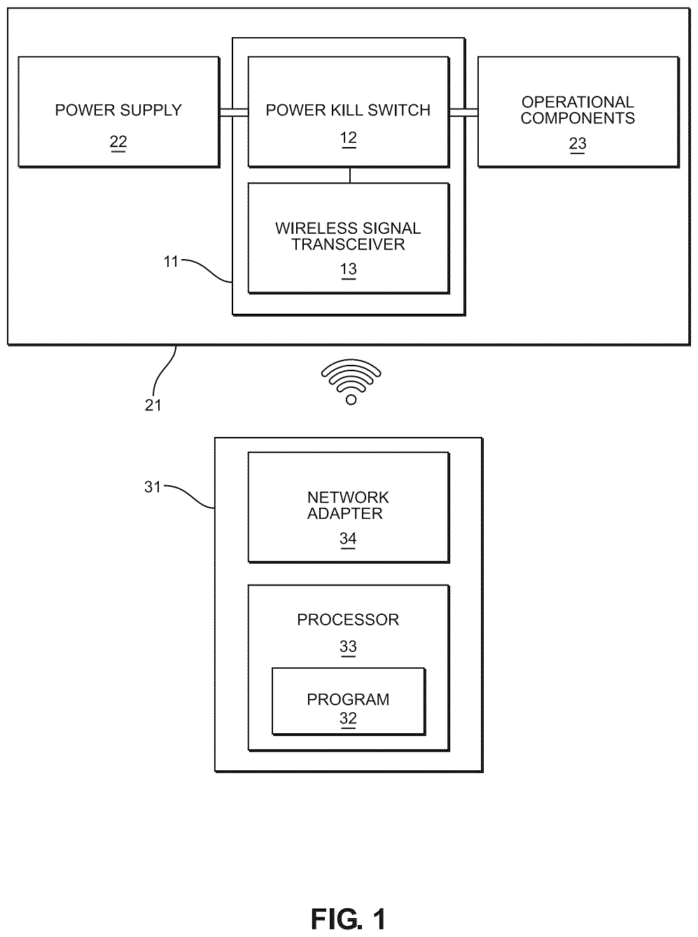

Referring now to FIG. 1, there is shown a first block diagram of an embodiment of the wireless control system for a household appliance. The wireless control system for a household appliance comprises an electronic housing 11. The electronic housing 11 is of any suitable material for providing protection for the internal components of the electronic housing 11. For example, the electronic housing 11 should provide protection from tampering, from exposure to any harmful elements (such as water or static electricity), and from ordinary wear and tear associated with household appliances.

The electronic housing 11 is configured to be secured within a household appliance 21. For example, the electronic housing 11 may be installed in a washer, a dryer, a refrigerator, an oven, a dishwasher, or any other household appliance. Ideally, the electronic housing 11 will be discreet in its placement within the household appliance 21 such as to reduce the risk of tampering. Furthermore, the electronic housing 11 will be of a small construction as to reduce the risk of the household appliance user from discovering the electronic housing 11. The electronic housing 11 may also be of a color selected to blend into the internal components of the household appliance 21. In some embodiments, the electronic housing comprises a battery, such as a lithium battery, to supply power to the components of the electronic housing 11.

The electronic housing 11 comprises a power kill switch 12. The power kill switch 12 is designed to disable and to enable a power connection to the household appliance 21. As such, the power kill switch 12 is placed between the power supply 22 of the household appliance 21 and the operational components 23. Being placed between the power supply 22 and the operational components 23, the power kill switch 12 will be able to disrupt the flow of electricity to the operational components, rendering the household appliance 21 unusable. The specific placement of the power kill switch 12 and the electronic housing 11 may vary depending on the household appliance 21 on which the electronic housing 11 is installed. For example, when installed upon a conventional dryer, the electronic housing 11 may be installed between the motor and the electric plug inside of the internal cavity of the dryer. As such, the dryer will not be able to rotate or generate heat, rendering it unusable. The power kill switch 12 is reversable, such that power can be resupplied to the household appliance 21 in the event that the situation causing the shutoff is rectified. Additionally, the power kill switch 12 may be in operable connection with the power supply 22 via placement upon a computerized motherboard construct of the household appliance 21.

The power kill switch 12 is in operable connection with a wireless signal transceiver 13. The wireless signal transceiver 13 is configured to enable engagement of the power kill switch 12 from a remote location, relative to the electronic housing 11 and the household appliance. In the illustrated embodiment, the wireless signal transceiver 13 is configured to receive a signal from a remote device 31, such as a mobile phone or a computer. In such an embodiment, the wireless signal transceiver 13 is configured to receive a signal from the remote device 31 via a wireless internet network or other wireless network. As such, the remote device 31 must comprise a processor 33 configured to run an application or program 32 that is capable of generating the signal as well as a network adapter 34 that is capable of transmitting the signal via the wireless internet network or by a cellular network or the like.

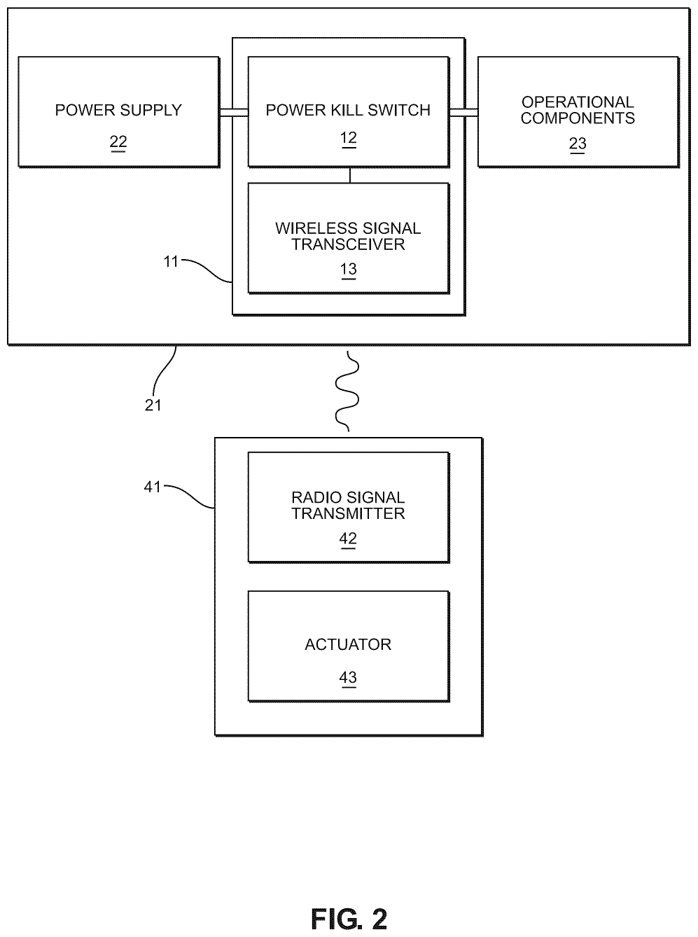

Referring now to FIG. 2, there is shown a second block diagram of an embodiment of the wireless control system for a household appliance. In the illustrated embodiment, the wireless signal transceiver 13 is configured to receive a radio wave signal. The radio wave signal may be a short range radio wave signal or a long range radio wave signal. The radio wave signal is released from a radio wave emitter 41. The radio wave emitter 41 comprises a radio signal transmitter 42 in operable connection with an actuator 43.

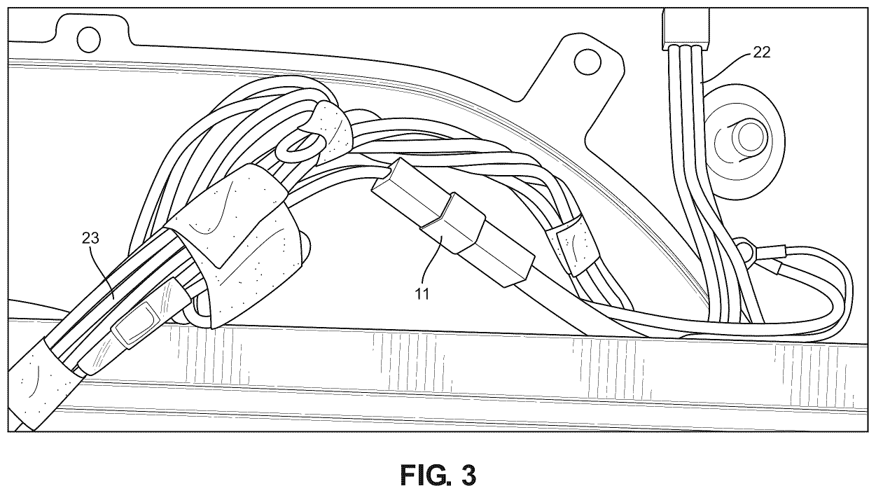

Referring now to FIG. 3, there is shown a demonstrative view of an embodiment of the wireless control system for a household appliance. In the illustrated embodiment, the electronics housing 11 is shown affixed between the cord leading to the power supply 22 and a cord leading to the operational components 23 of the household appliance. In use, the power kill switch may be utilized to shut off the electricity to an appliance from a remote location. As such, when used in combination with a leased household appliance, the lessee will be able to prevent use of the household appliance in the event that the lessor fails to make payments. Rendering the household appliance to be unusable from a remote location provides for a safer and more cost-effective way of handling missed payments. Furthermore, by allowing quick and effective resupplying of power to the household appliance, the lessor will able to have power restored promptly upon repayment.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A wireless control system for a household appliance, comprising:
an electronic housing;
the electronic housing configured to be secured within the household appliance;
the electronic housing comprising a power kill switch;
the power kill switch is in operable connection with a power supply of the household appliance;
the power kill switch is in operable connection with a wireless signal transceiver.

2) The wireless control system for a household appliance of claim 1, wherein the electronic housing comprises a battery;
wherein the battery is a lithium battery.

3) The wireless control system for a household appliance of claim 1, wherein the power kill switch is in operable connection with the power supply via placement upon a power line of the household appliance.

4) The wireless control system for a household appliance of claim 1, wherein the power kill switch is in operable connection with the power supply via placement upon a computerized motherboard construct of the household appliance.

5) The wireless control system for a household appliance of claim 1, wherein the wireless signal transceiver is from a wireless internet network.

6) The wireless control system for a household appliance of claim 1, wherein the wireless signal transceiver is a short range radio transceiver;
wherein the wireless signal transceiver is a long range radio transceiver.

7) The wireless control system for a household appliance of claim 1, wherein the wireless signal transceiver is in operable connection with a remote device.

8) The wireless control system for a household appliance of claim 7, wherein the remote device is a mobile phone.

9) The wireless control system for a household appliance of claim 8, wherein the mobile phone comprises an application configured to enable and disable the power kill switch.

10) The wireless control system for a household appliance of claim 7, wherein the remote device is a computer.

11. The wireless control system for a household appliance of claim 10, wherein the computer comprises a non-transitory computer readable medium to enable and disable the power kill switch.
